(19) United States
(12) Patent Application Publication
(10) Pub. No.: US 2011/0315240 A1
(43) Pub. Date: Dec. 29, 2011

(54) Ventilation valve

(75) Inventors: Matthias Müller, Schamback (DE); Jürgen Theissler, Ansbach (DE)

(73) Assignee: Alfmeier Prazision AG Baugruppen und Systemlosungen, Treuchtlingen (DE)

(21) Appl. No.: 13/010,924

(22) Filed: Jan. 21, 2011

Related U.S. Application Data
(60) Provisional application No. 61/369,196, filed on Jul. 30, 2010.

(30) Foreign Application Priority Data
Jun. 23, 2010 (DE) 102010030456.5

(51) Int. Cl. F16K 31/18

(52) U.S. Cl. 137/409

(57) ABSTRACT

The invention refers to a ventilation valve for the fuel tank of a motor vehicle with a housing (2) that has a ventilation opening (28), a movably arranged float (5) in the housing in the direction of its middle longitudinal axis (16) and a float-held sealing element (29), which—seen in the top view towards the middle of the middle longitudinal axis (16) of the housing (2)—is fixed on the float (5) outside of the ventilation opening (28,28a) on the arranged fixing spot (35), in which case the ventilation opening (28,28a) has a non-circular opening contour and, extending away from the fixing spot (35), a terminal section (39) whose clear width (36) increases with increasing distance from the fixing spot (35), in which case the clear width (36) is measured transversally to an imaginary middle plane (37) that cuts the fixing point (35) in the center and contains the middle longitudinal axis (19) of the float (5).

The invention refers to a ventilation valve for the fuel tank of a motor vehicle, especially for one equipped with an Otto engine. Such a valve comprises a housing with a ventilation opening, a movably arranged float in direction of its middle longitudinal axis and a sealing element held by the float. Such a valve should ensure the aeration and de-aeration of the tank (to simplify things, only the word “ventilation” will be hereinafter) especially during the vehicle's operation. The float prevents fuel from escaping into the surroundings. If during the vehicle's operation (while driving a curvy road, for example) the fuel sloshes upwards, the float is lifted and moved to its closing position, so it can press the sealing element against the ventilation opening or its encompassing sealing seat. In this situation, excess pressure often builds up in the tank's interior with respect to the atmosphere so that the sealing element is impinged upon with a compressive force from the tank's interior resulting from the magnitude of the excess pressure and the area of the ventilation opening. This force counteracts the opening force exerted by the float on the sealing element so that the latter detaches only slowly from the ventilation opening or in an extreme case not at all.

The task of the invention is to suggest a ventilation valve that will ensure a re-opening already with relatively high tank internal pressures and a fast pressure reduction in the tank interior.

This task is solved with a valve of the type mentioned above by providing a ventilation opening with a largely non-circular opening contour and a terminal section extending away from the fixing spot whose clear width increases with increasing distance from the fixing spot. In this case, the clear width is measured transversely to an imaginary middle plane that cuts the fixing spot in the center and contains the middle longitudinal axis of the float. Because the laterally narrowed terminal section of the ventilation opening has a small width or several clear widths compared to an area that follows, which is farther away from the fixing spot, it has a correspondingly reduced area. Thus, with a given tank internal pressure for opening, in other words for pulling off the sealing element from the terminal section or one of these surrounding sealing seats the force needed for this is lower than the one for a perfectly circular ventilation opening, for example. As soon as the sealing element has started to detach from the terminal section, gas (i.e. a fuel vapor and air mixture) can start flowing outwards from the tank interior and lower the inner pressure. The pressure reduction, however, accelerates so much because of this that the clear width of the ventilation opening increases significantly more the farther away it is from the fixing spot and accordingly, the flow cross-section of the ventilation opening released by the sealing element and the gas flow interspersed in it, compared to a slit-shaped, constant clear width. The result is a fast re-opening of the valve and a quick pressure reduction in the tank interior.

In another preferred design, the ventilation opening has a pressure-holding function, generally ensured by a ventilation opening controlled by a closing body, which uses gravitational force to close a ventilation opening located in a transverse wall of the housing. The closing body is often shaped as a closing ball, in which case an upper side of the housing transverse wall that supports it is designed so the closing ball will roll towards the ventilation opening due to the gravitational force and close it. If fuel is now replenished in the tank using a filler neck mounted on it, the closing body counters the gas driven out from the tank with a resistance that increases the tank's internal pressure. The increased tank pressure causes that when towards the end of the filling process (in other words, when a filling level limiting valve installed in or on the tank closes because the fuel level has reached a certain height) the fuel starts rising in the filling neck and triggers the turning off of the pump nozzle.

Two different design variants are suggested for accomplishing the pressure-holding function. The first embodiment has a second ventilation opening controlled by the closing body that is fluidically connected to the ventilation opening controlled by the float and arranged on a separate transverse wall of the valve housing. In the case of a closing body shaped like a ball, the upper side of the transverse wall is shaped in such a way that the closing ball, owing to the gravitational force, will start rolling towards the ventilation opening (which has a circular opening contour) and close it.

In the second preferred embodiment, there is only one ventilation opening closed from the upper side of the transversal wall that supports it by a closing body. In this case, in an especially preferred embodiment, the ventilation opening has different opening contours. The opening contour on the side that faces the sealing element of the transverse wall interspersed with the ventilation opening is arranged in the manner described above, thus ensuring a fast re-opening of the ventilation opening. The opening contour on the other side (the upper side of the transversal wall), by contrast, is circular so it can be closed by a closing ball. Contrary to the first embodiment, no two separate transversal walls are therefore needed, and this reduces manufacturing expenses and assembly work. A valve housing with a transversal wall that is preferably interspersed by a ventilation opening having two different opening contours can be easily manufactured as an injection molded part. By contrast, a housing with two axially separated transversal walls, each one supporting an opening, could not be manufactured like that. Therefore, one of the two transverse walls would have to be attached to the valve housing as a separate part.

Preferably, and with regard to the planned middle plane mentioned above, the ventilation opening should have a mirror-symmetrical design to ensure that the sealing element would be impinged upon by the tank's internal pressure with the same force on both sides of the plane and accordingly, the float moving away from the ventilation opening in the direction of the opening would be uniformly stressed and prevented from tilting with respect to its middle longitudinal axis. An uneven stress on the float carries the risk that it will get stuck in the valve housing.

The invention will now be clarified with the help of the enclosed illustrations, which show:

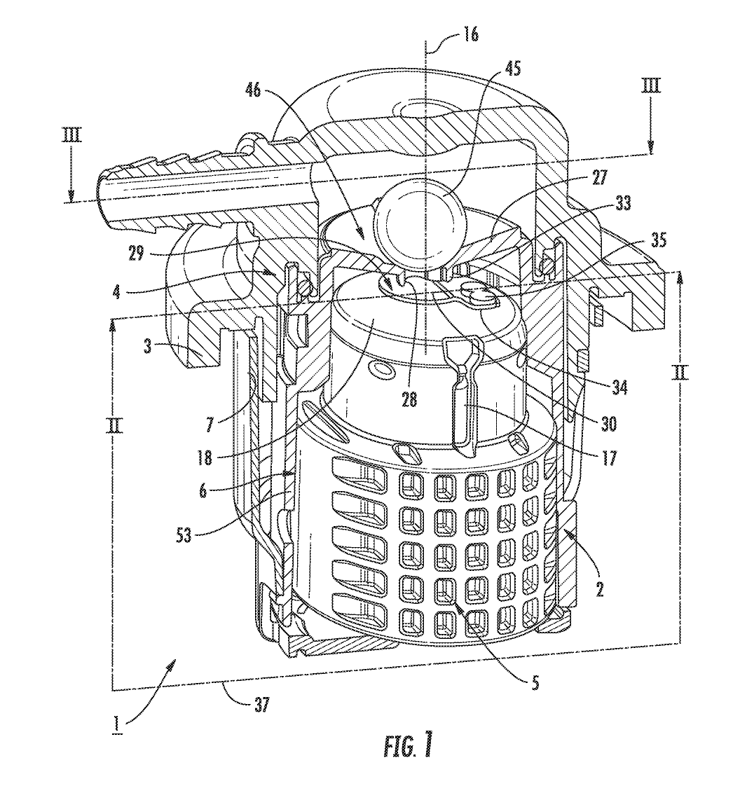

FIG. 1: A ventilation valve in a partially cut longitudinal section in perspective view,

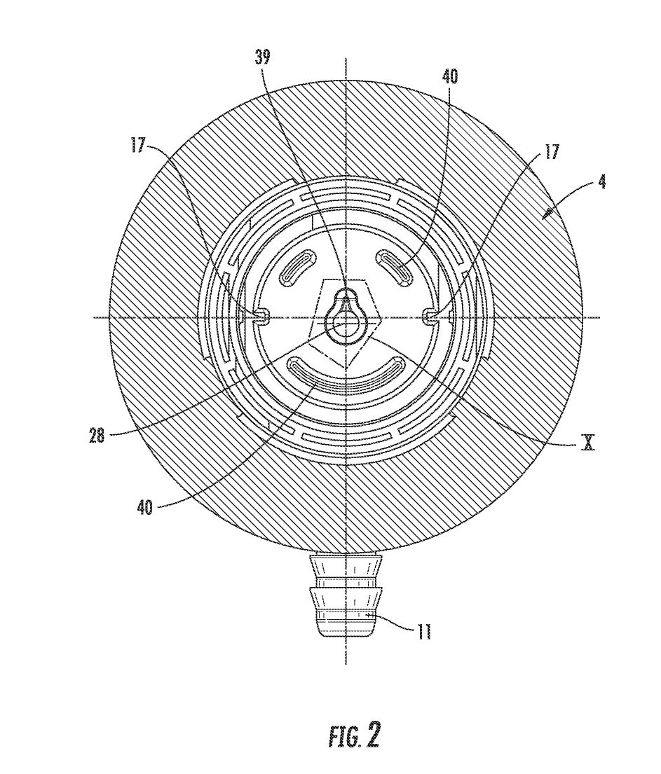

FIG. 2: A cross section that corresponds to line II-II in FIG. 1,

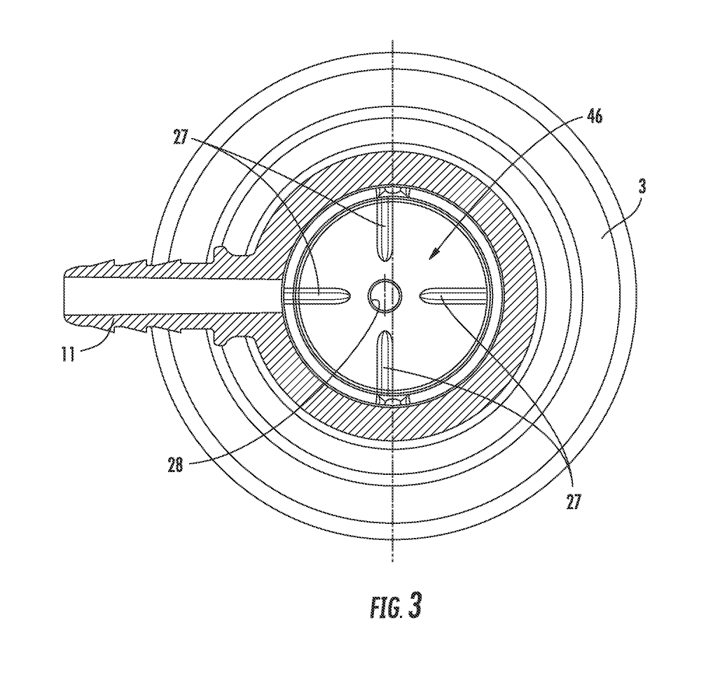

FIG. 3: A cross section that corresponds to line III-III in FIG. 1,

FIG. 4: A middle longitudinal section through the ventilation valve of FIG. 1,

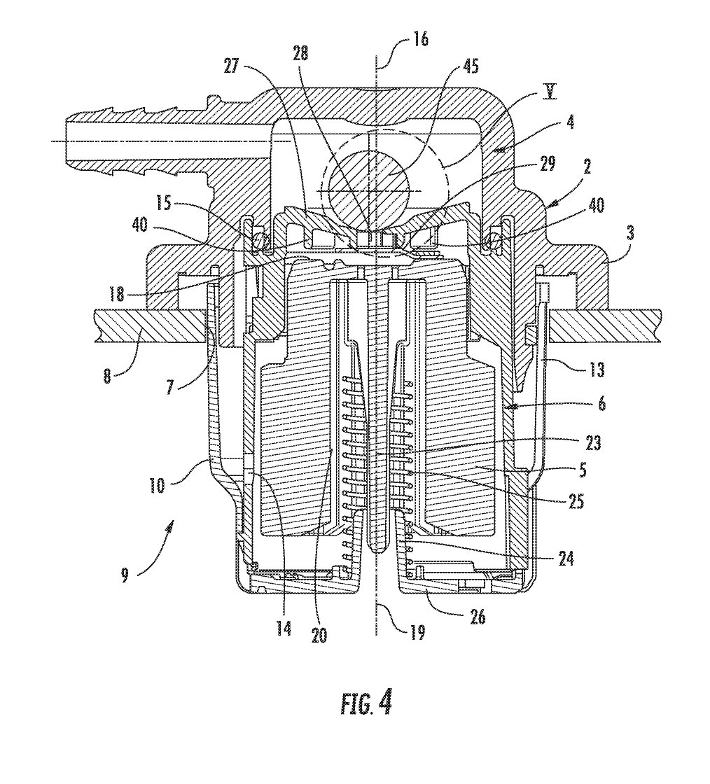

FIG. 5: The cut-out V in FIG. 4,

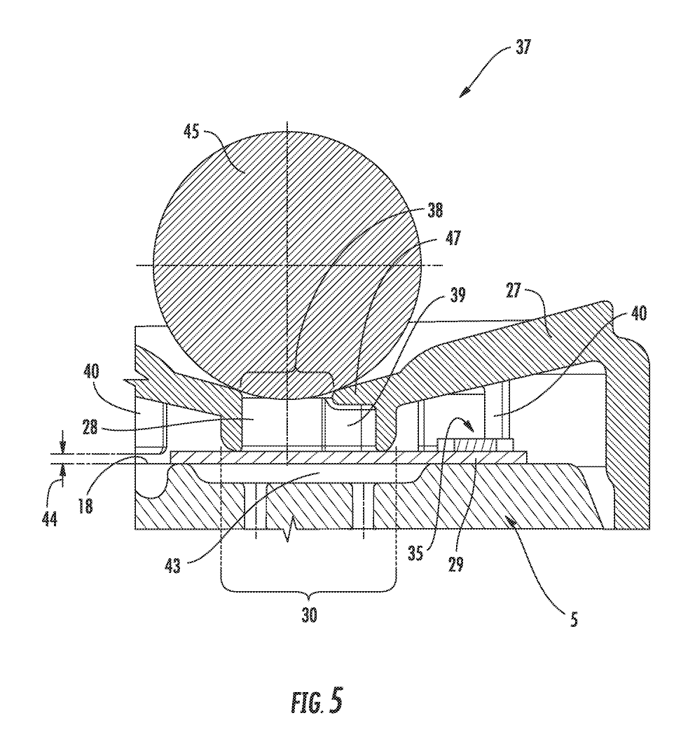

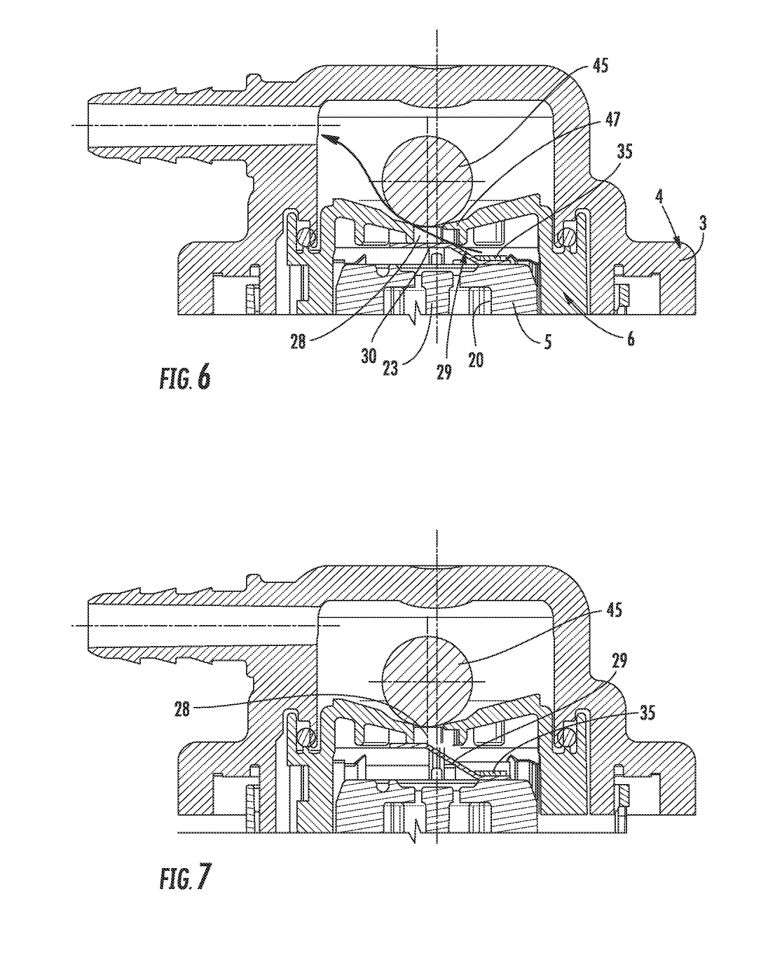

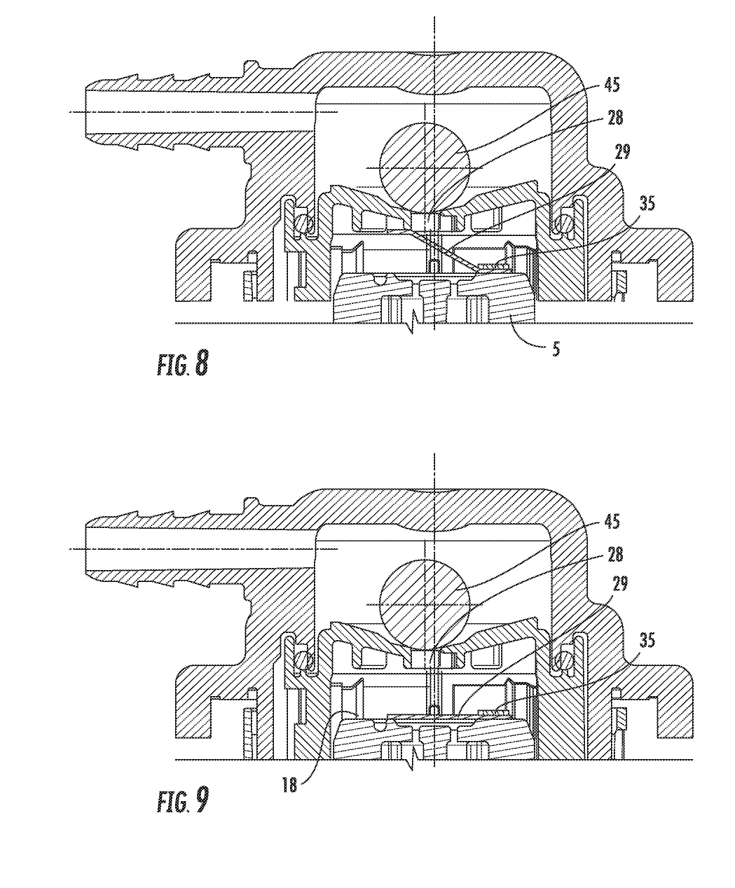

FIGS. 6-9: Longitudinal section views that clarify the opening process of the ventilation valve of FIG. 1,

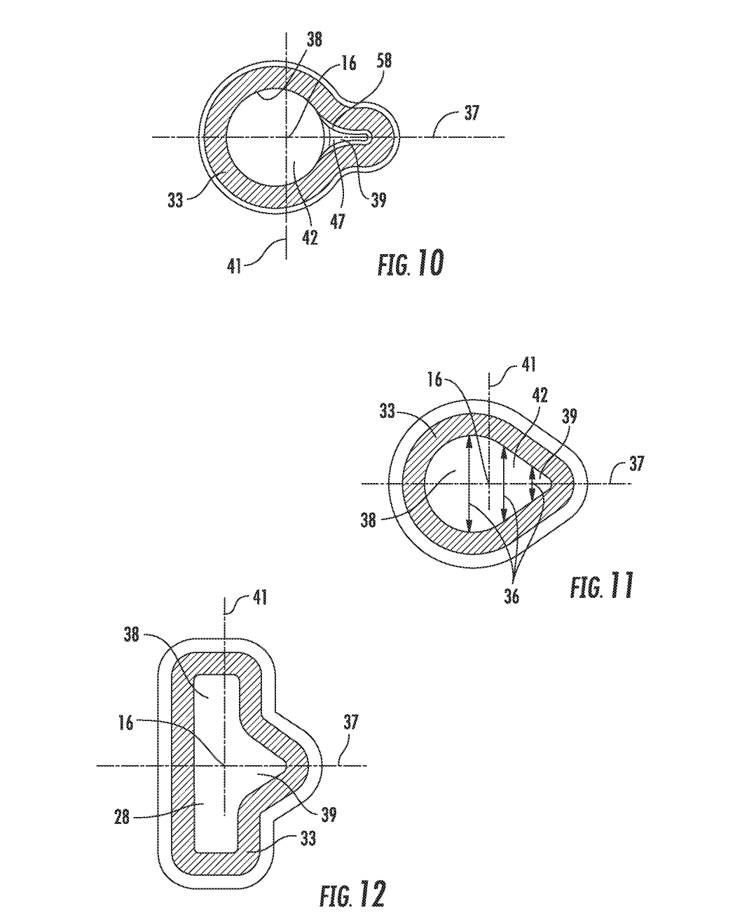

FIG. 10: A ventilation opening in accordance with cut-out X of FIG. 2,

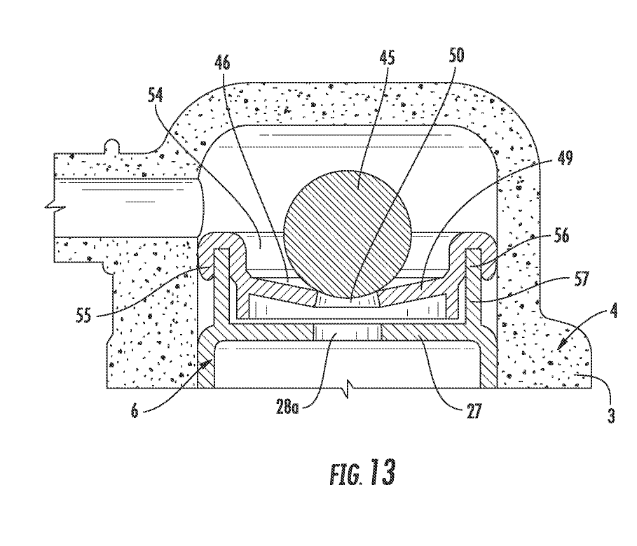

FIGS. 11 & 12: Alternatively designed ventilation openings in a view corresponding to FIG. 10,

FIG. 13: The upper part of an alternatively designed ventilation opening shown in a schematic longitudinal view.

A ventilation valve of the kind according to the invention encompasses, as best shown in FIGS. 1 & 4, a housing 2 made up of an upper housing part 4 that has a flange 3 and a connecting sleeve 11, and a lower housing part 6 for accepting a float 5. In the assembled state, the lower housing part protrudes into the interior 9 of a fuel tank through an opening 7 of the upper wall 8 (FIG. 4). The lower housing part 6 is surrounded by a more or less cylindrical wall 10 that constitutes a sloshing protection and is broken through by radially-spaced openings 13. The lower housing part 6 is also broken through by several openings 14 that facilitate the exchange of fuel and gas between the tank interior 9 and the interior of the housing 2.

The float 5 is movably arranged in direction of the middle longitudinal axis 16 of the housing 2. For axially guiding and rotationally fixing the float 5, at least one axial groove 17 is located in an upper section of its circumferential area. In the groove, an axial rail (not shown) engages the inside of the lower housing part 6. The upper side 18 of the float 5 has a largely flat design and extends transversally towards the middle longitudinal axis 19 of the float. The float 5 has a central bore hole 20, on whose base a central guiding rod 23 that extends axially has been formed. The guiding rod 23 protrudes into a hollow cylindrical projecting part 24, which axially extends away from the underside of the housing part 6. The projecting part 24 is encompassed by the lower end of a helical spring 25, which supports itself with its one end on a lower wall 26 of the housing part 6 and with its other end inside the bore hole 20 on the float 5.

The upper side of the housing part 6 is limited by a transverse wall 27, which is broken through by a ventilation opening 28 that is fluidically connected to the connecting sleeve 11. This opening is arranged in the transversal wall 27 in such a way that it is interspersed by the middle longitudinal axis 16 of the housing 2. The ventilation opening 28 is controlled by a sealing element 29 fixed on the upper side 18 of the float 5. The sealing element 29 is a flexible membrane (made of a polymeric material, for example) with a sealing area 30 dimensioned so it can cover the ventilation opening 28 fully. The ventilation opening 28 is delimited by a sealing seat 33 that protrudes axially from the underside of the transverse wall 27. On the sealing area 30, a fixing section 34 has been formed with which the sealing element 29 on the float 5 is fixed to a fixing spot 35. Looking in the top view towards the middle longitudinal axis 19 of the float 5, this spot is located radially outside the ventilation opening 28, and therefore eccentrically arranged with regard to the middle longitudinal axis 19 of the float 5.

The ventilation opening 28 has a non-circular opening contour. To facilitate re-opening (in other words, to decrease the forces needed for pulling off the sealing element 29 from the sealing seat 33 of the ventilation opening when the opening process starts, see FIGS. 5 & 6), a terminal section 39 extending away from the fixing spot 35 is narrowed in wedge or slot shape, for example, in which case its clear width 36 extends away like an opening section. The clear width 36 here is measured transversally to an imagined middle plane 37 that the fixing spot 35 cuts in the center and that contains the middle longitudinal axis 16 of the float 5. Owing to this arrangement, the ventilation opening 28 is not mirror symmetrical with regard to a plane 41 extending perpendicularly to the imaginary middle plane 37 that contains the middle longitudinal axis 16 of the float 5. The rest of the opening area 38 that follows the narrowed terminal section 39 can ultimately be designed in any way as long as its clear width 36 increases at least in a longitudinal section 42 that follows the narrowed terminal section 39, for example, until the middle longitudinal axis 19 of the float 5 so that, after the sealing element 29 has been pulled off from the narrowed terminal section 39, the remaining opening area 38 is released as quickly as possible, thus ensuring a high gas throughput (FIGS. 6-9).

The narrowed terminal section 39 can—seen in the top view of FIGS. 11 & 12—be slit-shaped or designed in the form of a wedge that tapers towards the fixing spot. The ventilation opening 28 shown in FIG. 10 is roughly drop-shaped, in which case the narrowed terminal section 39 is slit-shaped and gradually merges with a rounded edge area 58 in the remaining opening area 38, which is largely circular. In the ventilation opening 28 shown in FIG. 11, the narrowed terminal section 39 is wedge-shaped. The wedge shape continues uninterruptedly in the remaining opening area 38—in other words, the clear width 36 keeps constantly increasing with increasing distance from the fixing spot, until the edge of the ventilation opening 28 finally takes the form of a circular arc. In the ventilation opening 28 shown in FIG. 11, the narrowed terminal section 39 is also wedge-shaped, whereas the remaining opening area, however, has roughly the form of a rectangle whose long sides extend transversally to the imaginary middle plane 37.

In FIG. 4, the ventilation valve is shown closed. In this case, the sealing area 30 of the sealing element 29 sits entirely on the sealing seat 33 so that the ventilation opening 28 is closed. On the underside of the transverse wall 27, axially protruding extensions 40 have been formed that act together with the upper side 18 of the float 5 and create a terminal stop in the closing position of the float 5. On the upper side 18 of the float, underneath the sealing area 30 of the sealing element 29, there is a recess 43, into which the sealing element 29 or its sealing area 30 moves around the segment 44, starting from the situation shown in FIG. 5, when the float sits with its upper side 18 on the extensions 40.

Starting with the situation shown in FIGS. 4 & 5, the ventilation valve can open only when the pressure in the interior 9 of a fuel tank drops so much that the weight-force of the float 5 is enough to peel the sealing element from the narrowed terminal section 39. Since this section, particularly in its end closest to the fixation spot 35, has only a small clear width 36 here, only a fraction of the total weight-force of the float 5 is enough for moving the sealing element 39 away from the sealing seat (FIG. 6). Now, gas can flow outward via the terminal section 39 through the ventilation opening 28 and the pressure starts decreasing in the tank interior 9. With increasing pressure loss, the compressive force acting on the entire sealing area 30 decreases, so that the sealing element 29 is now pulled off quickly from the float 5 moving downward until finally the ventilation opening 28 has been fully opened and the float has dropped so much that the sealing element has separated completely from the sealing seat 33 and sits flat on the upper side of the float (FIGS. 6-9).

The valve shown in the drawings has a pressure-holding function and there is a closing ball for maintaining it. The upper side of the transverse wall 27 has a funnel-shaped pit 46 that holds the closing ball 45 and the ventilation opening 28 has been arranged on the pit's deepest spot. Several somewhat radially-running ribs 21 separated from one another in circumferential direction jut out from the upper side of the transverse wall 27, and these ribs end with radial separation in front of the ventilation opening 28. Unlike the opening contour of the ventilation opening, on the lower side of the transverse wall 27 that faces the float 5, it has a circular opening contour on the upper side of the transverse wall 27. The sealing ball 45 sits on this opening contour in a sealing manner. The weight of the closing ball 45 is assessed so there is always a certain minimal pressure in the tank interior 9. As already described above, the minimal pressure serves to turn off the pump nozzle at the end of the filling-up process. In the case of an opening contour like the one shown in FIG. 10 or FIG. 11, the ventilation opening 28 has largely the shape of a circular cylinder and an opening area 38 with a circular arc-shaped edge that axially breaks through the transverse wall 27, in which case this area narrows in the direction of the fixation spot 35 to a terminal section 39 that tapers to a slit or wedge shape. The upper side of the terminal section 39 is closed by a wall area 47 of the transverse wall 27 that protrudes into the ventilation opening 28. FIG. 13 shows an embodiment of a ventilation valve with pressure-holding function in which there is also a ventilation opening 28a in a transverse wall 27. However, the opening contour acting together with the sealing element 29 (not shown in FIG. 13) having a design of the kind mentioned above continues in the upper side of the transverse wall 27. Consequently, the ventilation opening 28a cannot be closed by a closing ball 45 for maintaining a pressure-holding function. To accomplish this, above the transverse wall 27 there is a second transverse wall 49 whose upper side has a funnel-shaped pit 46 that is interspersed by a central ventilation opening 50 with a circular opening contour that acts together with the closing ball 45. Whereas in the embodiment described above the entire housing part (at least its transverse wall 27 and the side walls that extend axially) can be manufactured as one piece with the injection molding process, the transverse wall 49 in the embodiment according to FIG. 13 is a separate part that must be connected to the housing underside 6a in a gas-or pressure-tight manner. For this purpose, an apron 54 sticking out radially upwards with a downward beaded border 55 is formed on the edge of the transverse wall 49. In this case, the border 55 is radially so far away from the apron 54 that a groove 56 is created in which a collar 57 formed on the upper side of the transverse wall 27 can be used in a gas- or pres-sure-tight manner.

1. Ventilation valve for the fuel tank of a motor vehicle, the ventilation valve comprising:
a housing that has a ventilation opening, a movably arranged float in the housing in the direction of its middle longitudinal axis (46) and a float-held sealing element, which is fixed on the float outside of the ventilation opening on the arranged fixing spot, in which case the ventilation opening has a non-circular opening contour and, extending away from the fixing point, a terminal section whose with a clear width that increases with increasing distance from the fixing spot, in which case the clear width is measured transversally to an imaginary middle plane that cuts the fixing point in the center and contains the middle longitudinal axis of the float.

2. Ventilation valve according to claim 1, wherein the ventilation opening comprises a first ventilation opening and a second ventilation opening is closed by a closing body resting on the second ventilation opening that moves with the gravitational force and that is fluidically connected to the first ventilation opening.

3. Ventilation valve according to claim 2, wherein a closing ball acts as a closing body and the second ventilation opening has a circular opening contour.

4. Ventilation valve according to claim 2, wherein each of the first and second ventilation openings is arranged on a separate transverse wall of the housing.

5. Ventilation valve according to claim 1, wherein the ventilation opening intersperses a transverse wall of the housing and opens out into in the upper side of the transverse wall that faces away from the float and in the upper side is closed by a closing body resting on the ventilation opening that moves with gravitational force.

6. Ventilation valve according to claim 5, wherein the ventilation opening opens out into the upper side of the transverse wall and the closing body is a closing ball.

7. Ventilation valve according to claim 1, wherein the non-circular opening contour of the ventilation opening has a mirror-symmetrical design with regard to the middle plane.
